(19) United States
(12) Patent Application Publication
(10) Pub. No.: US 2006/0056848 A1
(43) Pub. Date: Mar. 16, 2006

(54) Optical cross connect apparatus

(75) Inventor: Tetsuya Nishi, Kawasaki (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/020,474

(22) Filed: Dec. 27, 2004

(30) Foreign Application Priority Data
Sep. 16, 2004 (JP) 2004-269990

(51) Int. Cl. H04J 14/00

(52) U.S. Cl. 398/45

(57) ABSTRACT

An optical XC apparatus is provided that is advantageous for the construction of a large-scale WDM optical network, and that minimizes signal loss variations between routes. The optical XC apparatus comprises four switch modules SWM1 to SWM4 each of which has, at each crosspoint in a matrix switch, a two-input, two-output wavelength routing element constructed from an acousto-optic tunable filter, wherein the input ports of the SWM1 and SWM3 are allocated as the input ports of the apparatus, the output ports of the SWM2 and SWM4 are allocated as the output ports of the apparatus, and the output ports and auxiliary output ports of SWM1 and SWM3 are connected to the input ports and auxiliary input ports of SWM2 and SWM4, to construct the optical XC apparatus. As the connections are made in such a manner that the number of intervening elements varies in an orderly manner, the output level relative to the input level can be made the same for all signals, irrespective of the routes they take, by providing level adjusters at both the input and output ports.

### BACKGROUND OF THE INVENTION

1. Field of the Invention

The present invention relates to an optical cross connect apparatus for enabling the construction of a large-scale network adapted to accommodate an increase in a number of wavelengths.

2. Description of the Related Art

With the increasing speed of information transmission and the increasing amount of information to be transmitted, there has developed a need to construct a network and a transmission system that provide a broader bandwidth and a larger capacity. As a means for implementing this, the construction of optical networks based on WDM (Wavelength Division Multiplexing) techniques has been proceeding. The core apparatus used in the construction of an optical network is the optical cross connect (optical XC) apparatus. FIG. 1 shows a configuration example of an optical network incorporating an optical XC system. The optical XC 10 is a piece of equipment that accommodates a plurality of incoming/outgoing optical transmission lines, and that routes wavelength-multiplexed optical signals, input from the incoming optical transmission lines, to the designated outgoing optical transmission lines on a wavelength-by-wavelength basis. In the case of long-haul transmission, an optical amplifier 14 is inserted between internode links 12 connecting the optical XC 10 to another node. The optical XC 10 is also connected to another communication equipment (for example, an electrical cross connect: electrical XC 18) via an intranode link 16. These pieces of equipment are controlled by an operation system 20 that manages the entire network.

In an optical network, as the transmission capacity increases, the number of wavelengths required for transmission has been increasing rapidly. However, as the number of wavelengths increases, the size of the optical switch required in the optical XC apparatus increases, thus making it increasingly difficult to implement the optical XC apparatus.

FIG. 2 shows an optical cross connect apparatus of a fixed wavelength type according to the prior art, and FIG. 3 shows an optical switch scale-up technique according to the prior art. As shown in FIG. 2, each wavelength-multiplexed signal is demultiplexed by a wavelength demultiplexer 22 into signals of different wavelengths, which are then routed through k×k optical switches 24 to the designated output ports on a wavelength-by-wavelength basis; after that, the signals are again wavelength-multiplexed by a wavelength multiplexer 26 and transmitted out on an outgoing transmission line. Here, when scaling up the optical switch size using k×k switches each constructed from a number, k², of 2×2 switch elements, the k×k switches 24 are arranged in a matrix pattern as shown in FIG. 3, and the input/output ports are connected to the switches adjacent in the horizontal and vertical directions in the figure.

In the optical cross connect apparatus and optical switch such as shown in FIGS. 2 and 3, if a large-capacity optical switch is to be constructed, an additional optical switch must be provided for each wavelength as the number of wavelengths increases. Further, when the number of input/output ports increases, a large-scale optical switch becomes necessary, and when the switch size becomes large, the longest path passes through three switch modules; for example, in the case of the 8×8 switch shown in FIG. 3, the signal from the input 1 to the output 8 passes through 15 switch elements, and as a result, the optical signal loss increases. On the other hand, the signal from the input 8 to the output 1 passes through only one switch element; in this way, the amount of signal loss varies greatly.

### SUMMARY OF THE INVENTION

Accordingly, an object of the present invention is to provide an optical cross connect apparatus that is advantageous for the construction of a large-scale WDM optical network, and that minimizes signal loss variations between routes.

According to the present invention, there is provided an optical cross connect apparatus comprising four switch modules each having a plurality of two-input, two-output wavelength routing elements that can take one of two connection states, a cross connection state and a bar connection state, independently of one another for each one of a plurality of wavelengths contained in a wavelength-division multiplexed signal, wherein the apparatus has input ports on the first and third of the switch modules and output ports on the second and fourth of the switch modules, and optical outputs of the first and third switch modules are input to the second and fourth switch modules.

In each of the first to fourth switch modules, the two-input, two-output wavelength routing elements are arranged, for example, one at each crosspoint of a matrix, thereby achieving a matrix switch independent of the others for the plurality of wavelengths.

Preferably, each of output ports of the first switch module is connected to one of auxiliary input ports of the second switch module; each of output ports of the third switch module is connected to one of auxiliary input ports of the fourth switch module; each of auxiliary output ports of the first switch module is connected to one of input ports of the fourth switch module; and each of auxiliary output ports of the third switch module is connected to one of input ports of the second switch module.

Further preferably, the output ports of the first switch module are connected to the auxiliary input ports of the second switch module that have the same depths from the input ports, respectively; the output ports of the third switch module are connected to the auxiliary input ports of the fourth switch module that have the same depths from the input ports, respectively; the auxiliary output ports of the first switch module are connected to the input ports of the fourth switch module that have the same depths from the output ports, respectively; and the auxiliary output ports of the third switch module are connected to the input ports of the second switch module that have the same depths from the output ports, respectively.

In one preferred mode of the invention, the first to fourth switch modules are each a PI-LOSS (Path Independent Loss) switch in which the two-input, two-output wavelength routing elements are arranged one at each crosspoint therein.

According to the present invention, there is also provided an optical cross connect apparatus comprising four switch modules, wherein: each of the switch modules comprises four sub-modules each of which has a plurality of two-input, two-output wavelength routing elements, one at each crosspoint of a matrix, that can take one of two connection states, a cross connection state and a bar connection state, independently of one another for each one of a plurality of wavelengths contained in a wavelength-division multiplexed signal, each of the sub-modules thus achieving a matrix switch independent of the others for the plurality of wavelengths; each of the switch modules has input ports on the first and third of the sub-modules and output ports on the second and fourth of the sub-modules; optical outputs of the first and third sub-modules are input to the second and fourth sub-modules; the apparatus has input ports on the first and third of the switch modules and output ports on the second and fourth of the switch modules; and optical outputs of the first and third switch modules are input to the second and fourth switch modules.

### BRIEF DESCRIPTION OF THE DRAWINGS

FIG. 1 is a diagram showing one example of an optical network incorporating an optical XC;

FIG. 2 is a diagram showing the configuration of a prior art optical XC apparatus;

FIG. 3 is a diagram showing an optical switch scale-up technique of a prior art;

FIG. 4 is a diagram showing the configuration of an optical XC apparatus according to one embodiment of the present invention;

FIG. 5 is a diagram for explaining the operation of an AOTF;

FIG. 6 is a diagram showing one example of the operation of the AOTF;

FIG. 7 is a diagram showing another example of the operation of the AOTF;

FIG. 8 is a diagram showing an example in which levels between wavelengths are made the same, irrespective of the routes they take, by adding level adjusters implemented by optical amplifiers to the optical XC apparatus of FIG. 4;

FIG. 9 is a diagram showing an example in which levels between wavelengths are made the same, irrespective of the routes they take, by adding level adjusters implemented by optical attenuators;

FIG. 10 is a diagram showing one modified example of the optical XC apparatus of FIG. 4;

FIG. 11 is a diagram showing an example in which levels between wavelengths are made the same, irrespective of the routes they take, by adding level adjusters to the optical XC apparatus of FIG. 10;

FIG. 12 is a diagram showing an example in which the optical XC apparatus of FIG. 4 is further scaled up;

FIG. 13 is a diagram showing the details of the connections in the optical XC apparatus of FIG. 12;

FIG. 14 is a diagram showing an example in which level adjusters are added to the optical XC apparatus of FIG. 12;

FIG. 15 is a diagram showing an example in which the optical XC apparatus of FIG. 10 is further scaled up;

FIG. 16 is a diagram showing still another example of the optical XC apparatus of the present invention;

FIG. 17 is a diagram showing an example in which the optical XC apparatus of FIG. 16 is further scaled up;

FIG. 18 is a diagram showing still another example of the optical XC apparatus of the present invention;

FIG. 19 is a diagram showing an example in which the optical XC apparatus of FIG. 18 is further scaled up;

FIG. 20 is a diagram showing yet another example of the optical XC apparatus of the present invention;

FIG. 21 is a diagram showing an example in which the optical XC apparatus of FIG. 20 is further scaled up;

FIG. 22 is a diagram showing still another example of the optical XC apparatus of the present invention; and

FIG. 23 is a diagram showing an example in which the optical XC apparatus of the present invention is used in an optical network node.

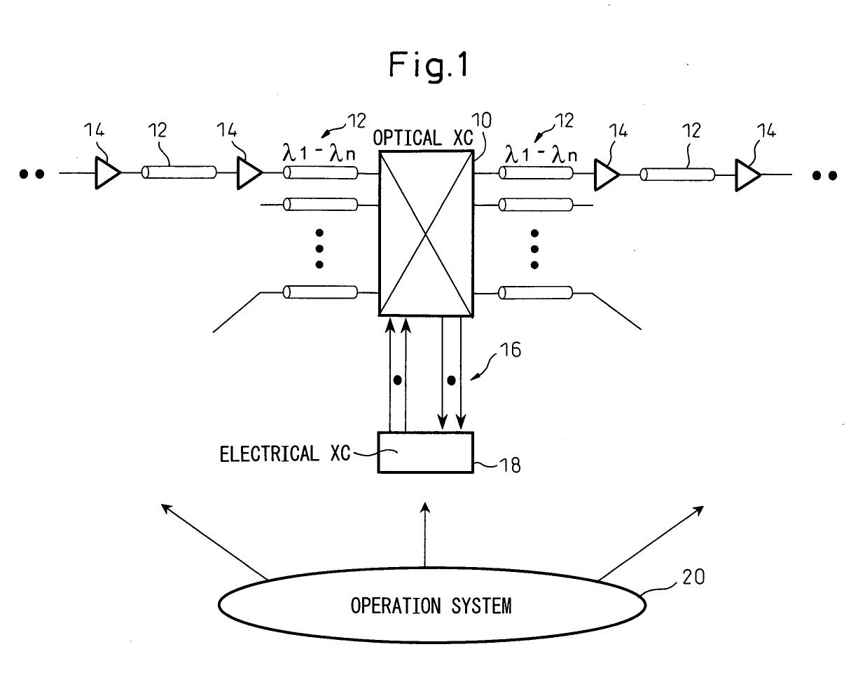

### DESCRIPTION OF THE PREFERRED EMBODIMENTS

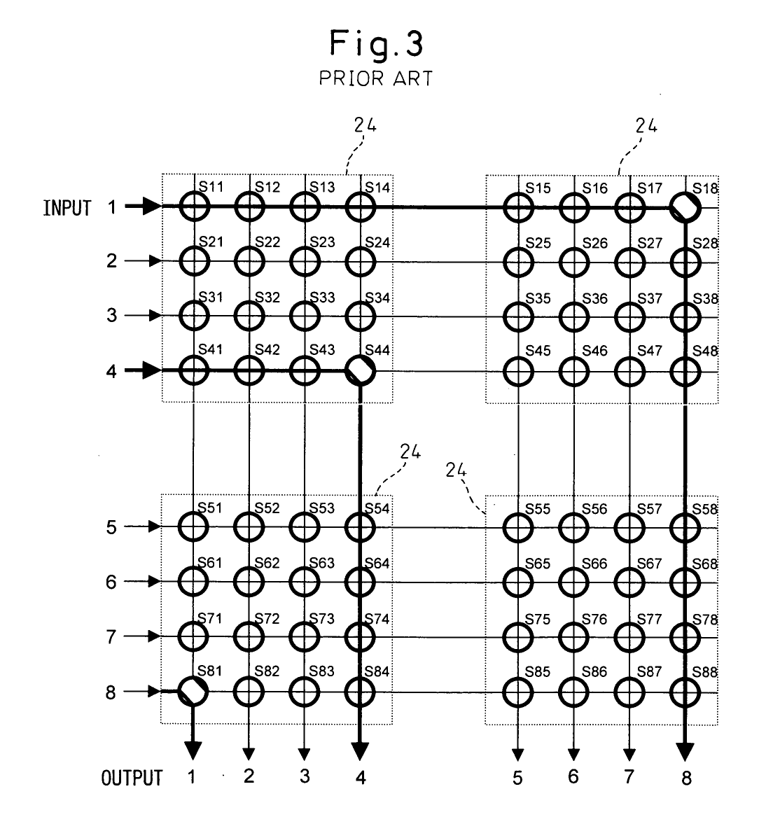

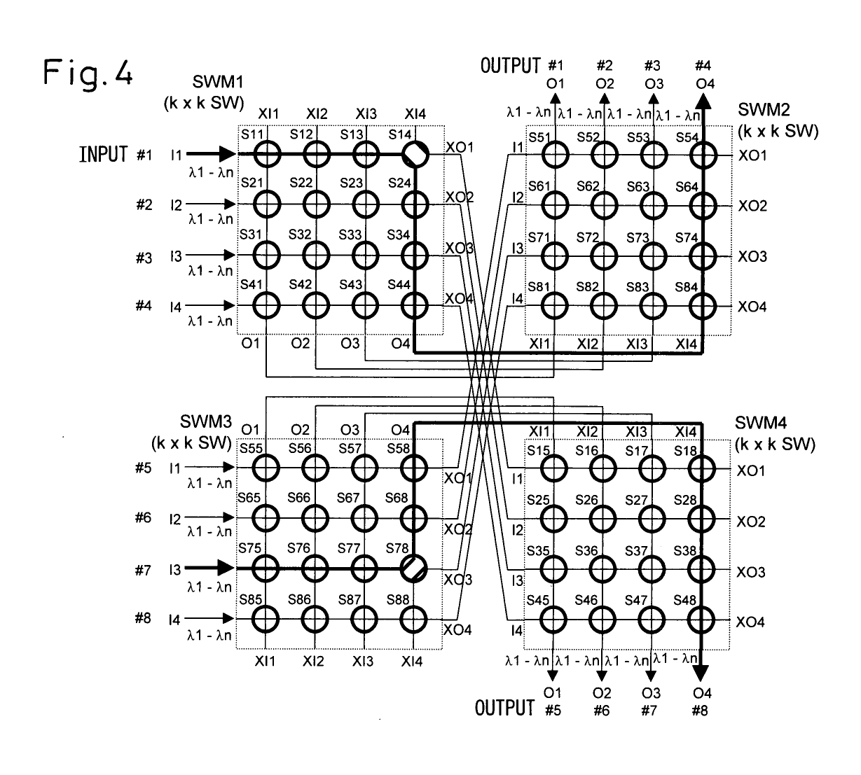

FIG. 4 shows the configuration of an optical XC apparatus according to one embodiment of the present invention. The optical XC apparatus shown in FIG. 4 comprises four switch modules SWM 1 to 4 each constructed from a k×k switch matrix, like the prior art optical switch shown in FIG. 3, but the difference is that the 2×2 switch elements at the crosspoints in each switch matrix are replaced by two-input, two-output wavelength routing elements that can take a cross connection state or a bar connection state independently of one another for each one of a plurality of wavelengths contained in a wavelength-division multiplexed signal.

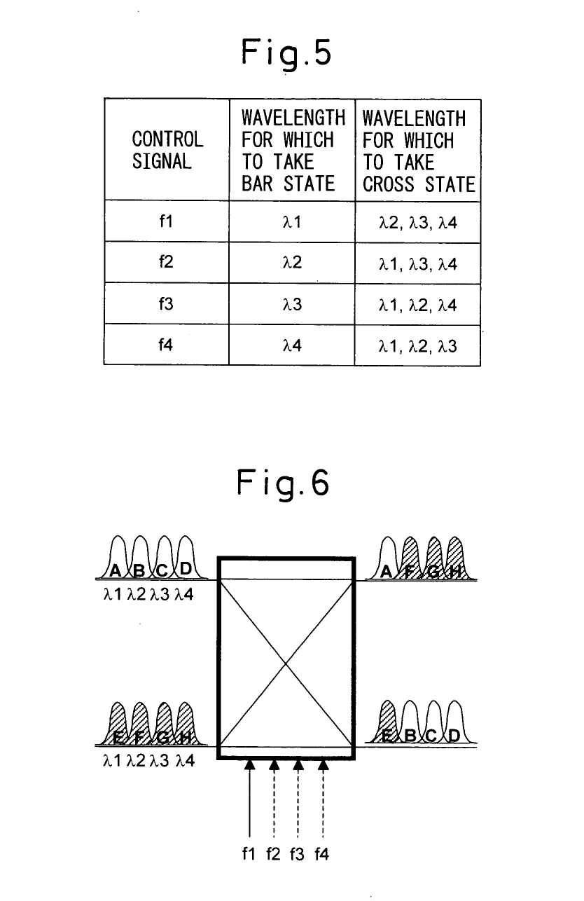

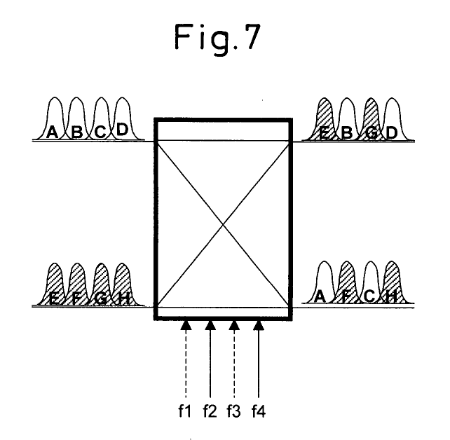

The two-input, two-output wavelength routing elements can each be implemented using, for example, an acousto-optic tunable filter (AOTF) such as shown in FIGS. 5 to 7. As shown in FIG. 5, when a control signal of frequency f₁ is given, the AOTF takes the bar connection state for its corresponding wavelength λ₁, and when control signals of frequencies f₂ to f₄, respectively, are given, the AOTF takes the bar connection state for their respectively corresponding wavelengths λ₂ to λ₄. For example, consider a situation where, as shown in FIG. 6, a WDM signal carrying signals A, B, C, and D of wavelengths λ₁, λ₂, λ₃, and λ₄ are input from the upper left input, while a WDM signal carrying signals E, F, G, and H of wavelengths λ₁, λ₂, λ₃, and λ₄ are input from the lower left input, and a signal of frequency f₁ is given as the control signal; then, as the bar connection state is taken only for the wavelength λ₁ and the cross connection state for the other wavelengths, a WDM signal carrying the signals A, F, G, and H is output from the upper right output, while a WDM signal carrying the signals E, B, C, and D is output from the lower right output. On the other hand, when the control signals of frequencies f₂ and f₄ are given, as shown in FIG. 7, the bar connection state is taken for the wavelengths λ₂ and λ₄ and the cross connection state for the wavelengths λ₁ and λ₃.

Turning back to FIG. 4, and noting, for example, the upper left switch module SWM1, when the control signal f₁, for example, is given to the wavelength routing element S14, then, of the wavelengths λ₁ to λₙ contained in the WDM signal input from the input port I1, only λ₁ is output from the output port O4, and the other wavelengths are output from an auxiliary output port XO1. That is, each of the switch modules SWM1 to SWM4 is a switch matrix which can perform routing for each individual wavelength contained in the input WDM signal, independently of one another.

Therefore, according to the switch matrices used in the optical XC of the present invention, each wavelength contained in the WDM signal input from each input port can be routed to the designated output port without demultiplexing the WDM signal into signals of different wavelengths.

As for the connections between the switch modules SWM1 to SWM4, the input ports I1 to I4 of SWM1 and SWM3 are allocated as the input ports #1 to #8 of the entire apparatus, and the output ports O1 to O4 of SWM2 and SWM4 are allocated as the output ports #1 to #8 of the entire apparatus. The optical outputs of SWM1 and SWM3 are all input to SWM2 or SWM4.

More specifically, in each of the switch modules SWM1 to SWM4, the ports located on the side opposite from the input ports I1 to I4, and connected to the respective input ports I1 to I4 when all the wavelength routing elements in the same row take the cross connection state, are designated as auxiliary output ports XO1 to XO4, respectively, and the ports located on the side opposite from the output ports O1 to O4, and connected to the respective output ports O1 to O4 when all the wavelength routing elements in the same column take the cross connection state, are designated as auxiliary input ports XI1 to XI4, respectively; then, each of the output ports O1 to O4 of SWM1 is connected to one of the auxiliary input ports XI1 to XI4 of SWM2, each of the output ports O1 to O4 of SWM3 is connected to one of the auxiliary input ports XI1 to XI4 of SWM4, each of the auxiliary output ports XO1 to XO4 of SWM1 is connected to one of the input ports I1 to I4 of SWM4, and each of the auxiliary output ports XO1 to XO4 of SWM3 is connected to one of the input ports I1 to I4 of SWM2.

When the switch modules are connected in this manner, every wavelength always passes through two switch modules irrespective of the path it takes, and signal loss variations between paths can thus be minimized.

In each switch module, the distances by which the output ports O1 to O4 and the auxiliary input ports XI1 to XI4 are respectively separated from the input ports are defined as the “depths from the input ports” of the output ports and the auxiliary input ports, respectively. For example, the output port O1 and the auxiliary input port XI1, which belong to the same column in the matrix, are closest to the input ports and are at the same depth, while the output port O4 and the auxiliary input port XI4, which belong to the same column in the matrix, are farthest from the input ports and are at the same depth.

Likewise, the distance by which the auxiliary output ports XO1 to XO4 and the input ports I1 to I4 are respectively separated from the output ports are defined as the “depths from the output ports” of the auxiliary output ports and the input ports, respectively. For example, the auxiliary output port XO4 and the input port I4, which belong to the same row in the matrix, are closest to the output ports and are at the same depth, while the auxiliary output port XO1 and the input port I1, which belong to the same row in the matrix, are farthest from the output ports and are at the same depth.

Using these definitions, the connections in the routing apparatus of FIG. 4 can be further described as follows: the output ports O1 to O4 of SWM1 are connected to the auxiliary input ports XI1 to XI4 of SWM2 that have the same depths from the input ports, respectively; the output ports O1 to O4 of SWM3 are connected to the auxiliary input ports XI1 to XI4 of SWM4 that have the same depths from the input ports, respectively; the auxiliary output ports XO1 to XO4 of SWM1 are connected to the input ports I1 to I4 of SWM4 that have the same depths from the output ports, respectively; and the auxiliary output ports XO1 to XO4 of SWM3 are connected to the input ports I1 to I4 of SWM2 that have the same depths from the output ports, respectively.

When the switch modules are connected in this manner, the signal loss between paths varies in an orderly fashion as shown in Table 1 and, as will be described later, the level differences between wavelengths can be eliminated by just adjusting the optical power level of the WDM signal at both the input and output ports.

TABLE 1
Number of intervening elements for all
connection patterns in optical XC of FIG. 4

| | | Loss |
|---|---|---|
| | | (number of |
| Input | Output | intervening |
| port | port | elements) |
| 1 | 1 | 8 |
| 1 | 2 | 9 |
| 1 | 3 | 10 |
| 1 | 4 | 11 |
| 1 | 5 | 8 |
| 1 | 6 | 9 |
| 1 | 7 | 10 |
| 1 | 8 | 11 |
| 2 | 1 | 7 |
| 2 | 2 | 8 |
| 2 | 3 | 9 |
| 2 | 4 | 10 |
| 2 | 5 | 7 |
| 2 | 6 | 8 |
| 2 | 7 | 9 |
| 2 | 8 | 10 |
| 3 | 1 | 6 |
| 3 | 2 | 7 |
| 3 | 3 | 8 |
| 3 | 4 | 9 |
| 3 | 5 | 6 |
| 3 | 6 | 7 |
| 3 | 7 | 8 |
| 3 | 8 | 9 |
| 4 | 1 | 5 |
| 4 | 2 | 6 |
| 4 | 3 | 7 |
| 4 | 4 | 8 |
| 4 | 5 | 5 |
| 4 | 6 | 6 |
| 4 | 7 | 7 |
| 4 | 8 | 8 |
| 5 | 1 | 5 |
| 5 | 2 | 6 |
| 5 | 3 | 7 |
| 5 | 4 | 8 |
| 5 | 5 | 5 |
| 5 | 6 | 6 |
| 5 | 7 | 7 |
| 5 | 8 | 8 |
| 6 | 1 | 6 |
| 6 | 2 | 7 |
| 6 | 3 | 8 |
| 6 | 4 | 9 |
| 6 | 5 | 6 |
| 6 | 6 | 7 |
| 6 | 7 | 8 |
| 6 | 8 | 9 |
| 7 | 1 | 7 |
| 7 | 2 | 8 |
| 7 | 3 | 9 |
| 7 | 4 | 10 |
| 7 | 5 | 7 |
| 7 | 6 | 8 |
| 7 | 7 | 9 |
| 7 | 8 | 10 |
| 8 | 1 | 8 |
| 8 | 2 | 9 |
| 8 | 3 | 10 |
| 8 | 4 | 11 |
| 8 | 5 | 8 |
| 8 | 6 | 9 |
| 8 | 7 | 10 |
| 8 | 8 | 11 |

In FIG. 4, each of the four switch modules has been shown as forming a 4×4 switch matrix, but it will be recognized that the above and following discussions can generally be applied to optical cross connect apparatus that uses four switch modules each forming a k×k switch matrix where k is an integer not smaller than 2.

In FIG. 4 and in the diagrams described hereinafter, the designation Sxy (x, y=1, 2, 3, . . . ) attached to each wavelength routing element means that it is a wavelength routing element for routing the signal from input port x to output port y. For example, when a control signal of frequency fₜ is given to the wavelength routing element S14, causing it to take a bar connection state for the corresponding wavelength λₜ, then the wavelength λₜ contained in the WDM signal input from the input port #1 is routed to the output port #4, as shown by a thick line in FIG. 4. Likewise, when fₜ is given to S78, the wavelength λₜ is routed from the input port #7 to the output port #8.

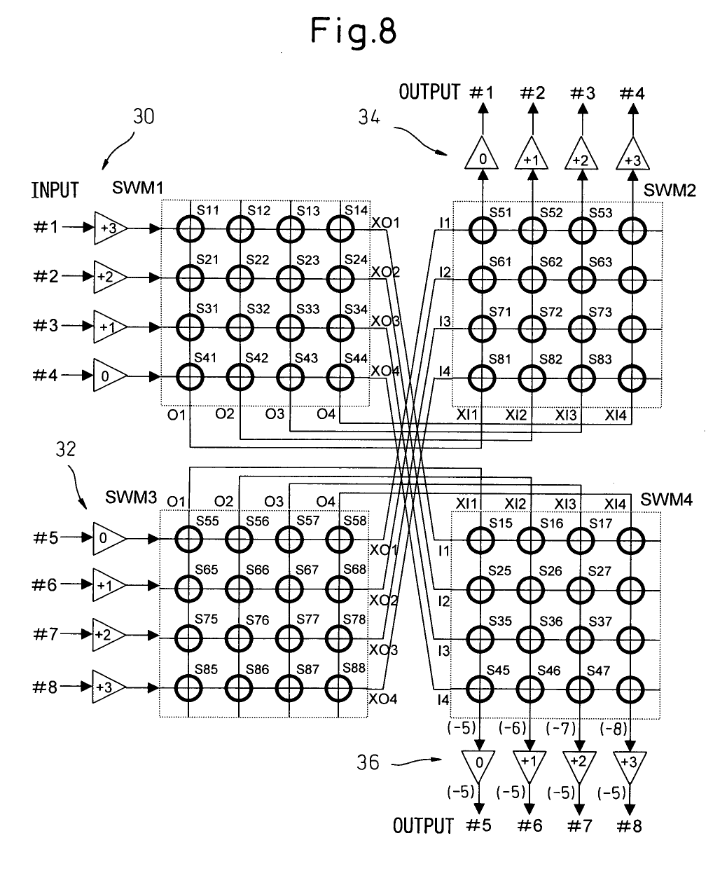

FIG. 8 shows an example in which the relative levels of the respective wavelengths are made the same, irrespective of the routes they take, by providing optical amplifiers 30, 32, 34, and 36 at the input ports #1 to #8 and output ports #1 to #8 of the optical cross connect of FIG. 4.

In FIG. 8, the numerical values in the optical amplifiers 30, 32, 34, and 36 indicate the gains of the amplifiers, the unity value indicating the gain necessary to compensate for the loss that the signal suffers by passing through one two-input, two-output wavelength routing element.

As shown in FIG. 8, the WDM signals input from the input ports #1 to #4 are given the gains +3, +2, +1, and 0 by the respective optical amplifiers 30 according to the depths from the output ports of SWM1, and likewise, the WDM signals input from the input ports #5 to #8 are given the gains +3, +2, +1, and 0 by the respective optical amplifiers 32 according to the depths from the output ports of SWM3.

With this arrangement, the wavelength input from the input port #1, for example, is first given the gain +3 by the optical amplifier 30 and then passes through four wavelength routing element for output at the output port O1 of SWM1 because of the bar connection state of S11 in SWM1, so that its relative level to the input level is +3−4=−1; in the case of the wavelength input from #3, the relative level is likewise +1−2=−1. That is, for any wavelength input from any one of #1 to #4, the relative level to the input level, when output at the output port O1, is always −1. Similarly, for any wavelength input from any one of the input ports #1 to #4, the relative levels of the wavelengths output at the output ports O2, O3, and O4 are always −2, −3, and −4, respectively. This also applies to SWM3; that is, for any wavelength input from any one of the input ports #5 to #8, the relative levels of the wavelengths output at the output ports O1 to O4 are always −1, −2, −3, and −4, respectively. Further, the relative levels of the wavelengths output at the auxiliary output ports XO1 to XO4 of SWM1 and SWM3 are always −1, −2, −3, and −4, respectively, because any wavelength passes through four wavelength routing elements.

As earlier described, the connections between the auxiliary output ports XO1 to XO4 of SWM1 and the input ports I1 to I4 of SWM4 are made by interconnecting the ports that have the same depths from the output ports in the respective modules; accordingly, the relative level of any wavelength that is input from any one of the input ports #1 to #4, and that reaches the output port #5 via a corresponding one of XO1 to XO4 of SWM1 and a corresponding one of I1 to I4 of SWM4 by being selected due to the bar connection of a corresponding one of S15, S25, S35, and S45, is always −5 at the input of the optical amplifier 36. Likewise, at the output ports #6 to #8, the relative levels are always −6, −7, and −8, respectively. Similarly, the connections between the output ports O1 to O4 of SWM3 and the auxiliary input ports XI1 to XI4 of SWM4 are made by interconnecting the ports that have the same depths from the input ports in the respective modules; accordingly, the relative levels of the wavelengths input from the input ports #5 to #8, and selected for output at the respective output ports #5 to #8, are −5, −6, −7, and −8, respectively, at the inputs of the respective optical amplifiers 36. Therefore, using the optical amplifier 36 that provides the gain appropriate to the depth from the input ports, the relative levels of all the wavelengths can be made the same, irrespective of the input ports #1 to #8 from which they were input. Likewise, using the optical amplifier 34, the relative levels of all the wavelengths can be made the same, irrespective of the input ports from which they were input.

That is, by providing the optical amplifiers 30, 32, 34, and 36 at the input and output ports, the relative level to the input level can be made the same for each wavelength of the WDM signal passing through the optical XC apparatus, irrespective of the route it passes through.

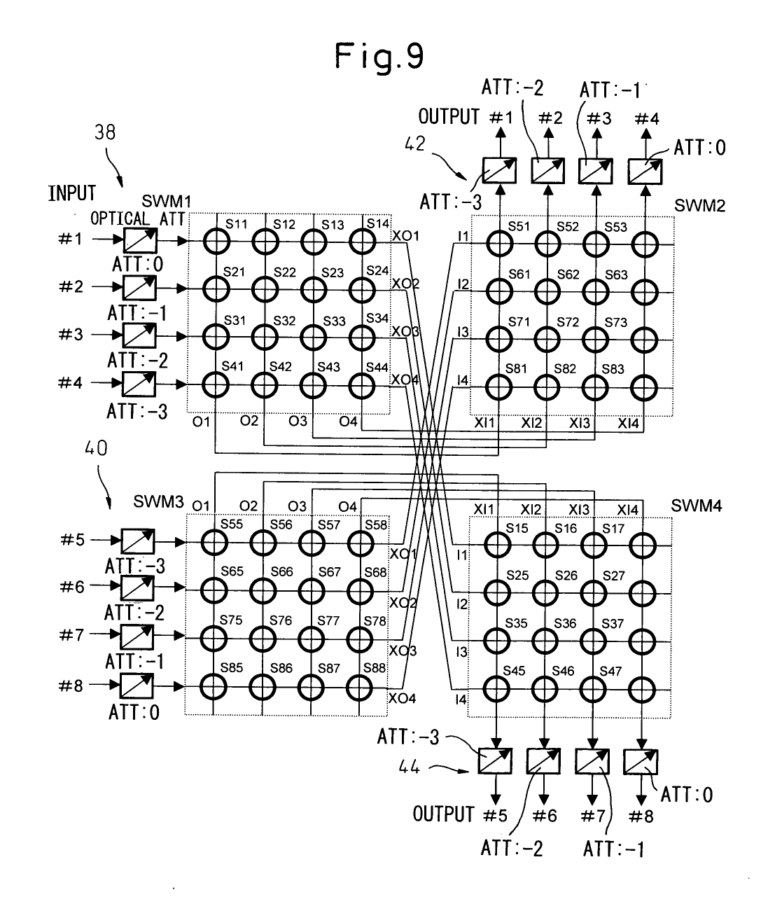

Rather than adjusting the levels using the optical amplifiers, the levels may be adjusted using optical attenuators 38, 40, 42, and 44, as shown in FIG. 9.

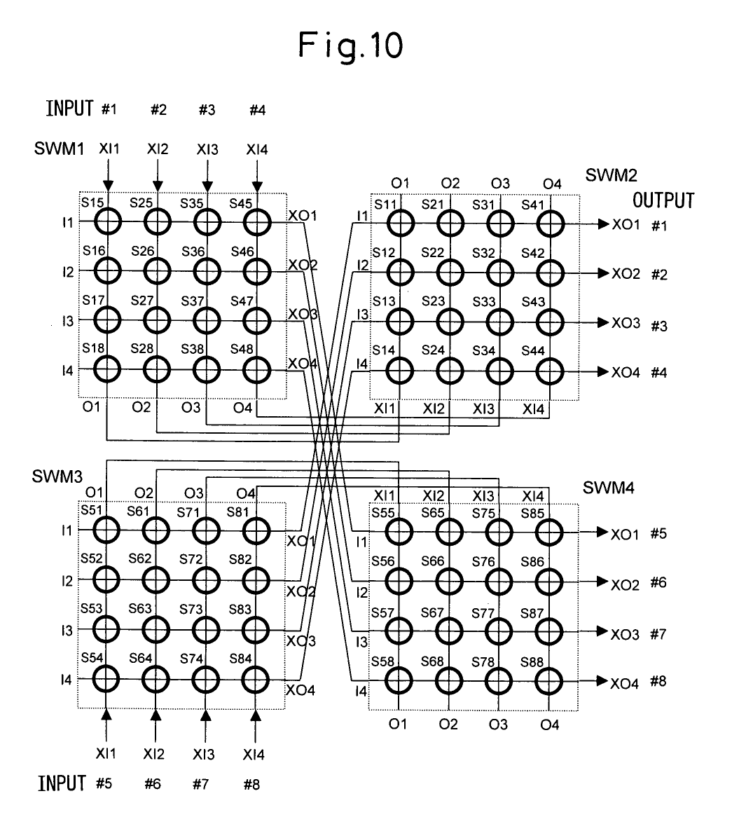

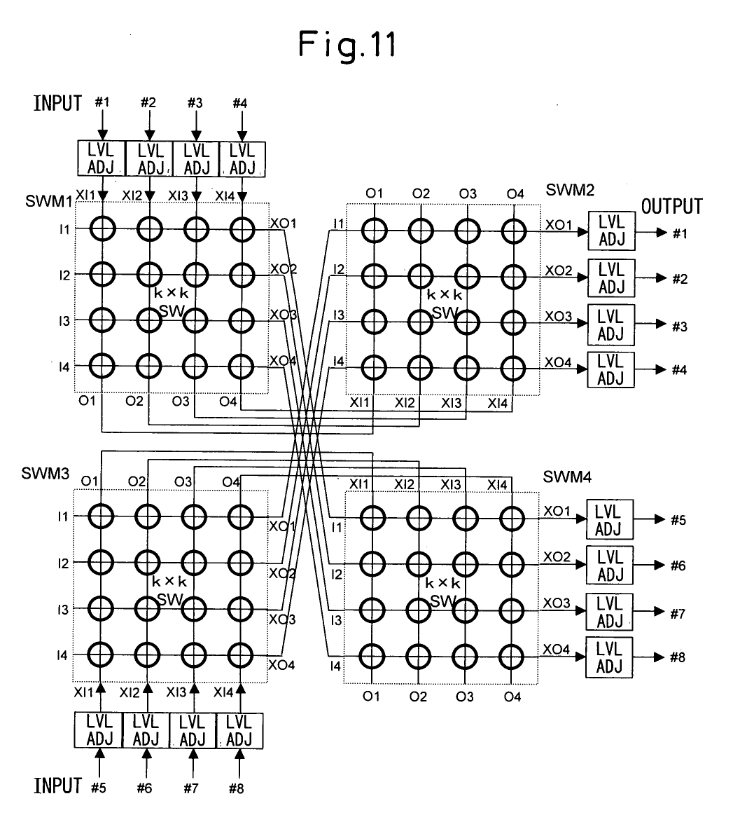

FIG. 10 shows a first modified example of the optical XC apparatus of FIG. 4. The connections between the switch modules are the same as those in FIG. 4, but in the modified example, the auxiliary input ports XI1 to XI4 of SWM1 and SWM3 are designated as the input ports of the optical XC apparatus, and the auxiliary output ports of SWM2 and SWM4 are designated as the output ports of the optical XC apparatus. In this case also, the number of intervening wavelength routing elements varies in an orderly fashion, as in the case of FIG. 4; therefore, by providing level adjusters, such as optical amplifiers or optical attenuators, at the input and output ports as shown in FIG. 11, the relative levels of all the wavelengths can be made the same irrespective of the routes they take.

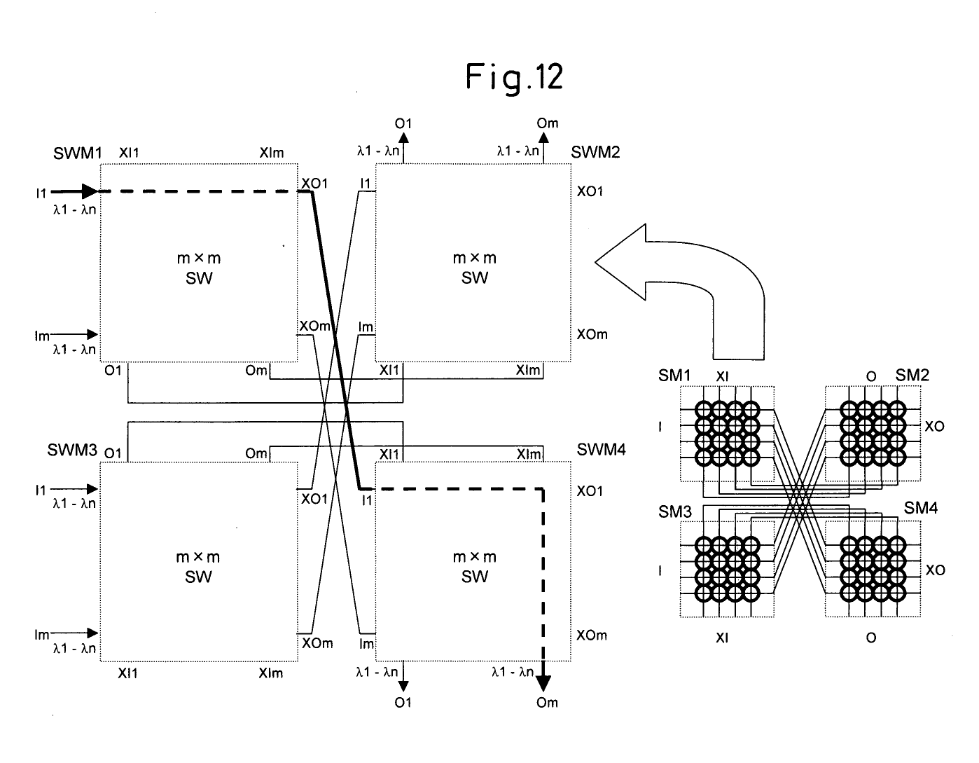

FIG. 12 shows an example in which a larger-scale optical XC apparatus is constructed using four modules, each being the optical XC apparatus having the configuration shown in FIG. 4. That is, the optical XC apparatus of FIG. 12 comprises four switch modules SWM1 to SWM4, each of which includes four sub-modules SM1 to SM4. The connections between the four sub-modules SM1 to SM4 are the same as the connections between the four switch modules SWM1 to SWM4 previously described with reference to FIG. 4. The input ports I of the sub-modules SM1 and SM3 function as the input ports I1 to Im of each of the switch modules SWM1 to SWM4, the output ports 0 of the sub-modules SM2 and SM4 function as the output ports O1 to Om of each of the switch modules SWM1 to SWM4, the auxiliary input ports XI of the sub-modules SM1 and SM3 function as the auxiliary input ports XI1 to XIm of each of the switch modules SWM1 to SWM4, and the auxiliary output ports XO of the sub-modules SM2 and SM4 function as the auxiliary output ports XO1 to XOm of each of the switch modules SWM1 to SWM4. The connections between the ports of the switch modules SWM1 to SWM4 in FIG. 12 are the same as the connections between the ports of the sub-modules SM1 to SM4 forming each of the switch modules SWM1 to SWM4 or the connections between the ports of the switch modules SWM1 to SWM4 shown in FIG. 4; that is, the ports having the same depths from the input ports or the output ports in the respective sub-modules SM1 to SM4 are connected together.

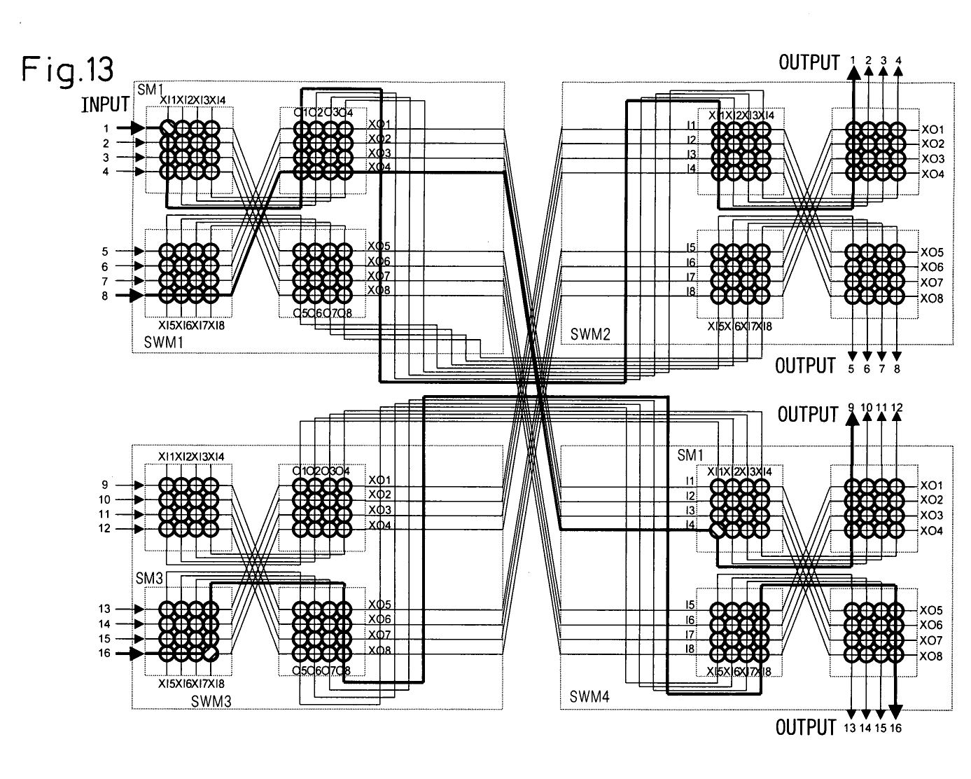

FIG. 13 shows the details of the connections. For example, the connections between the auxiliary output ports XO1 to XO8 of the switch module SWM1 and the input ports I1 to I8 of the switch module SWM4 are made by interconnecting the ports that have the same depths from the output ports in the respective sub-modules. In the example of FIG. 13, the wavelength routing element in the upper left corner of the sub-module SM1 in the switching module SWM1 is supplied with the control signal fₜ to take a bar connection state for the wavelength λₜ corresponding to fₜ so that, for the wavelength λₜ, the input 1 is connected to the output 1, and the wavelength routing element in the lower right corner of the sub-module SM3 in the switching module SWM3 is supplied with the control signal fₜ to take a bar connection state for the wavelength λₜ corresponding to fₜ so that, for the wavelength λₜ, the input 16 is connected to the output 16, while the wavelength routing element in the lower left corner of the sub-module SM1 in the switching module SWM4 is supplied with the control signal fₜ to take a bar connection state for the wavelength λₜ corresponding to fₜ so that, for the wavelength λₜ, the input 8 is connected to the output 9; these connections are indicated by thick lines in the figure.

FIG. 13 has shown the XC optical apparatus of 16×16 configuration constructed from four 8×8 modules each comprising four 4×4 modules; generally, by using four k×k modules, the configuration can be scaled up to a 2k×2k module, and by using four such modules, the configuration can be further scaled up to construct 4k×4k optical XC apparatus, which could be further scaled up using the same technique. When designing an optical XC apparatus of a certain scale, it will be best to start with a 2×2 module from the standpoint of minimizing the loss variation, because the variation in the number of intervening elements can be made smaller as k is made smaller, but this in turn increases the number of scale-up steps, making the interconnection lines complex. Therefore, the value of k must be determined based on a tradeoff between the above two factors, but it is thought that k=4 is optimum.

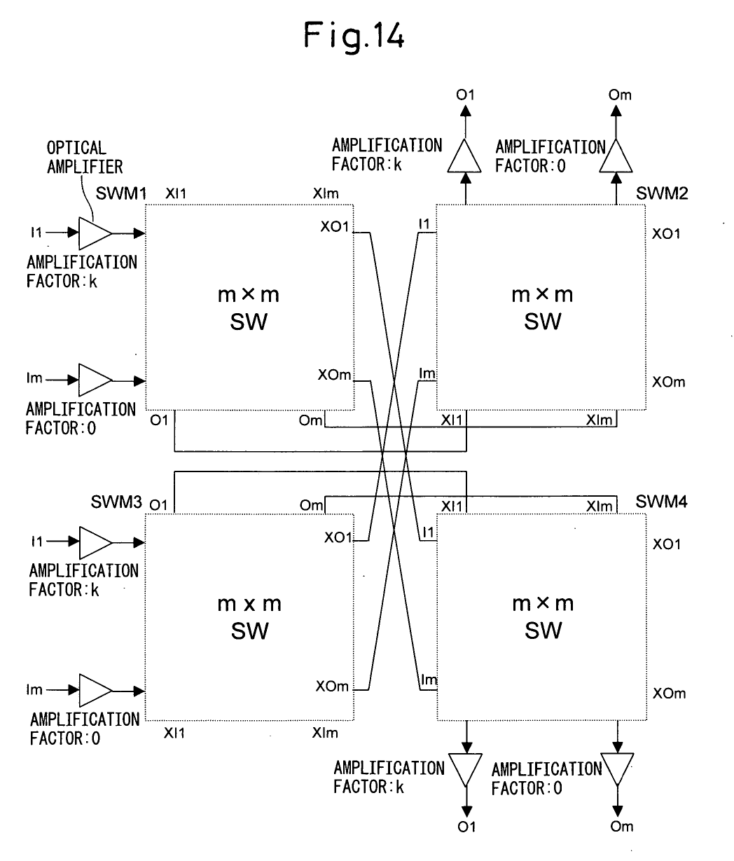

FIG. 14 shows the configuration in which the optical output level relative to the optical input level is made the same for all wavelengths, irrespective of the routes they take, by providing optical amplifiers (or optical attenuators) at the input and output ports of the optical XC apparatus of the doubly scaled up configuration shown in FIGS. 12 and 13. The amplification factor (or attenuation factor) of each optical amplifier is set in accordance with the depth from the output port or output port in its associated sub-module in each switch module. Optical amplifiers may be further provided in the paths connecting from the switch modules SM1 and SM3 to the switch modules SM2 and SM4. Such optical amplifiers are provided just to amplify the optical signals, but not to adjust the level difference between the routes.

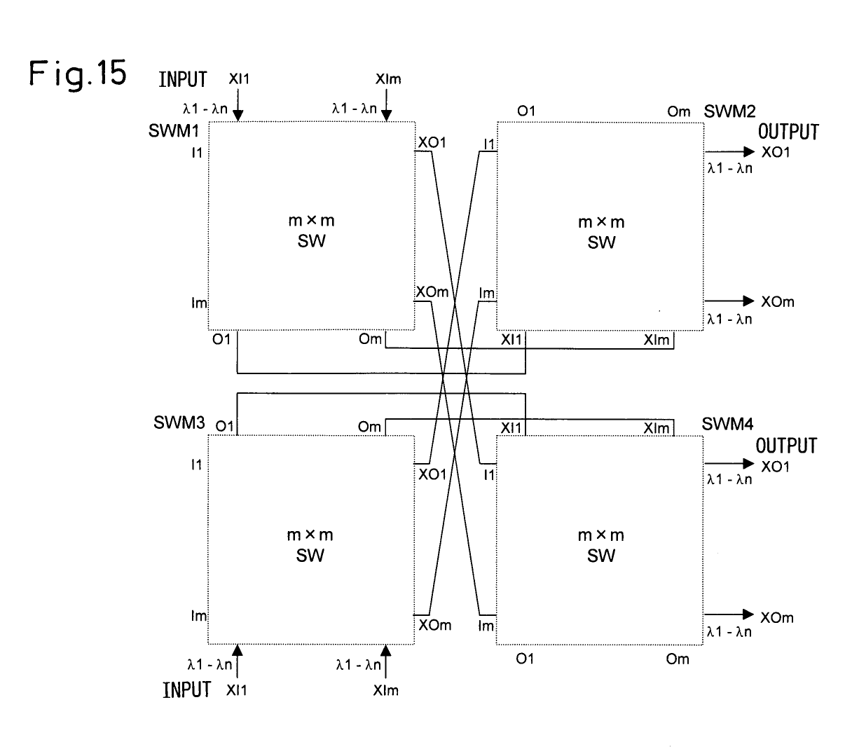

FIG. 15 shows an example in which the connection configuration of the type shown in FIG. 10 is scaled up. The internal connections are the same as those in FIGS. 12 and 13, but in this example, the auxiliary input ports XI1 to XIm of the switch modules SWM1 and SWM3 function as the input ports of the optical XC apparatus, and the auxiliary output ports XO1 to XOm of SWM2 and SWM4 function as the output ports of the optical XC apparatus. In this case also, as in the example shown in FIG. 14, the relative level can be made the same for all wavelengths, irrespective of the routes they take, by providing the level adjusters that give level differences in accordance with the depths from the input ports or output ports in the input-side and output-side sub-modules.

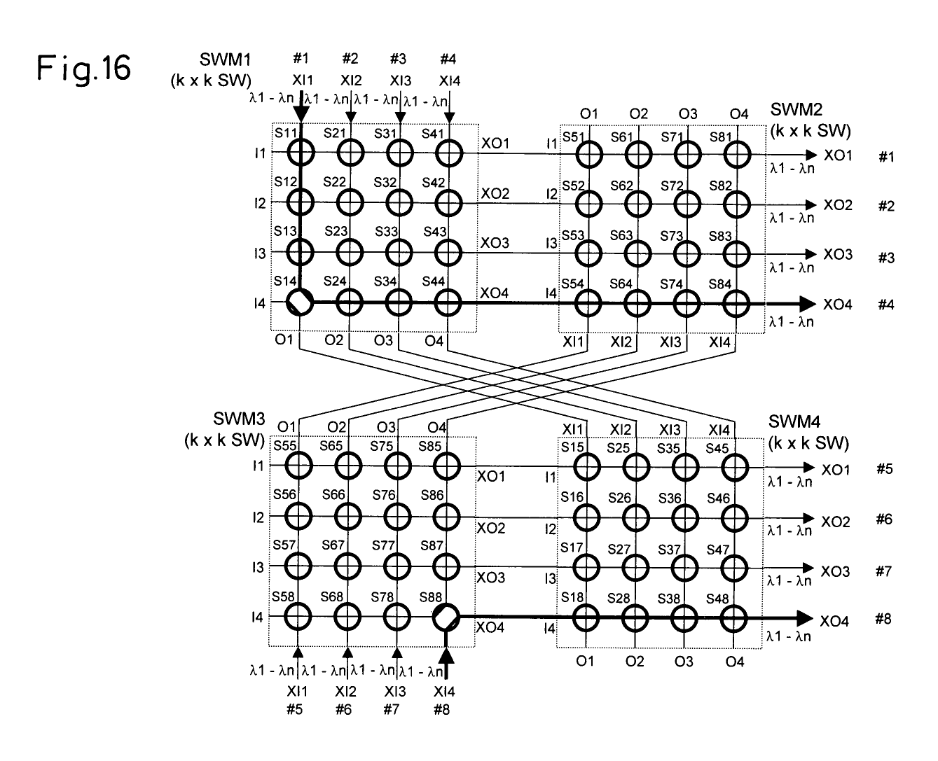

FIG. 16 shows another example of the connections between the switch modules. The connections shown are the same as those in FIG. 10 in that all the outputs of the SWM1 and SWM3 are input to SWM2 and SWM4, and in that the output ports of SWM1 and SWM3 are connected to the auxiliary input ports of SWM2 and SWM4, while the auxiliary output ports of SWM1 and SWM3 are connected to the input ports of SWM2 and SWM4. However, in the example shown, the connections between the XO1 to XO4 of SWM1 and the I1 to I4 of SWM2 are not made by interconnecting the ports that have the same depths from the output ports O1 to O4, and the connections between the XO1 to XO4 of SWM3 and the I1 to I4 of SWM4 are not made in the order of the depths from the output ports O1 to O4. Accordingly, the relative level cannot be made the same for all wavelengths, irrespective of the routes they take, by providing level adjusters as shown in FIG. 11. However, in the prior art connections shown in FIG. 3, the largest number of intervening elements was 15 and the smallest number was 1, that is, the difference was as large as 14 depending on the route, whereas in the connections shown in FIG. 16, the difference is reduced to 6, that is, the largest number is 11 and the smallest number is 5, as shown by thick lines in the figure.

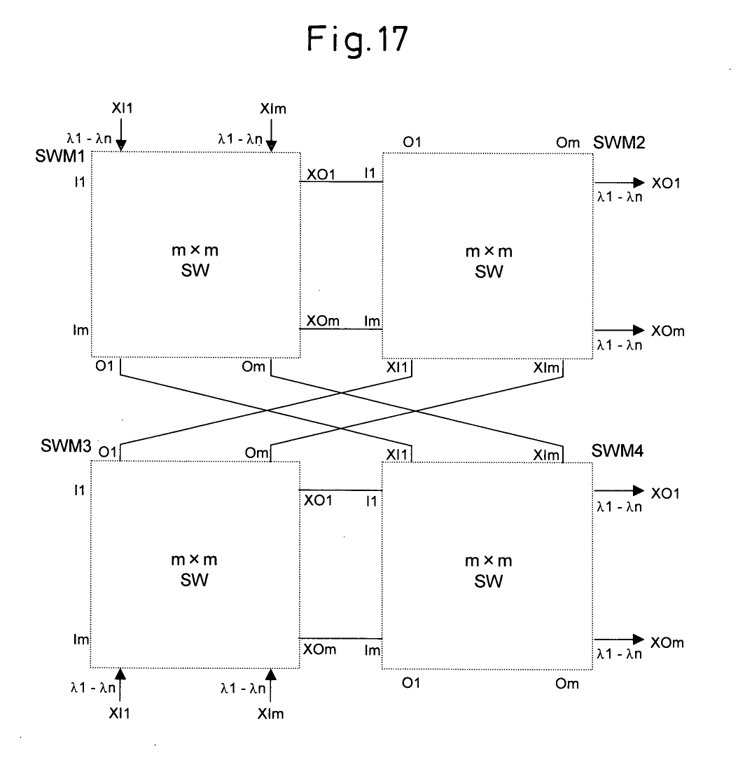

FIG. 17 shows an example in which the connection configuration of FIG. 16 is scaled up in the same manner as that shown in FIG. 12.

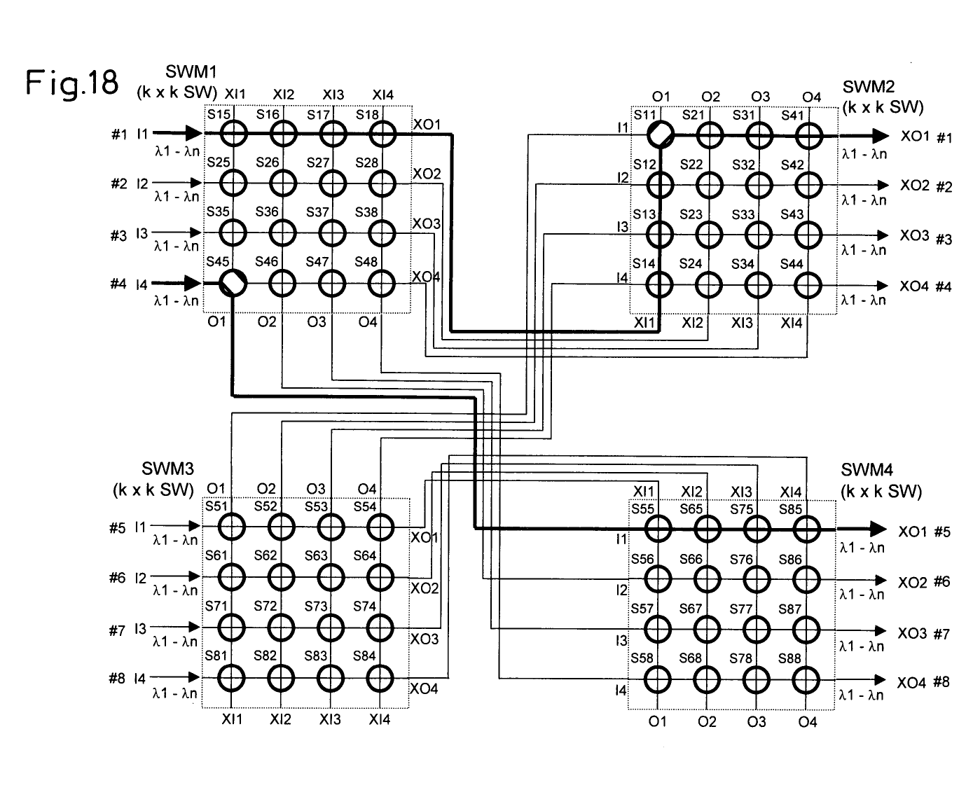

FIG. 18 shows still another example of the connections between the switch modules. The connections shown are the same as those in FIG. 4 in that all the outputs of the SWM1 and SWM3 are input to SWM2 and SWM4. Accordingly, as shown by thick lines in the figure, the largest number of intervening elements is 11 and the smallest number is 5, the difference being 6.

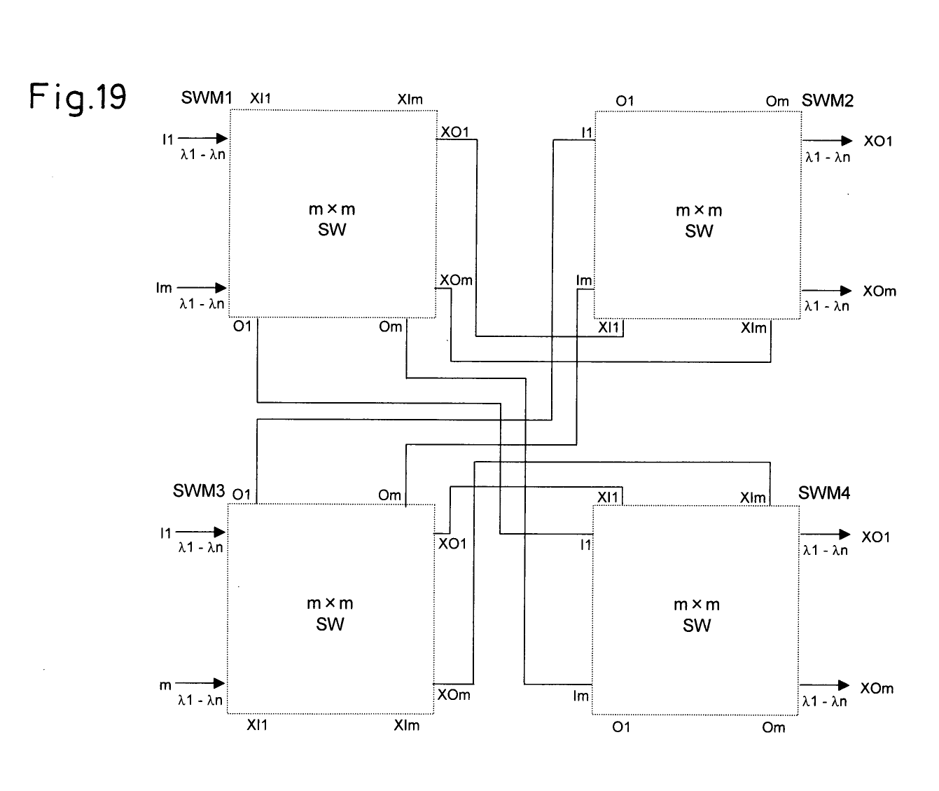

FIG. 19 shows an example in which the connection configuration of FIG. 18 is scaled up in the same manner as that shown in FIG. 12.

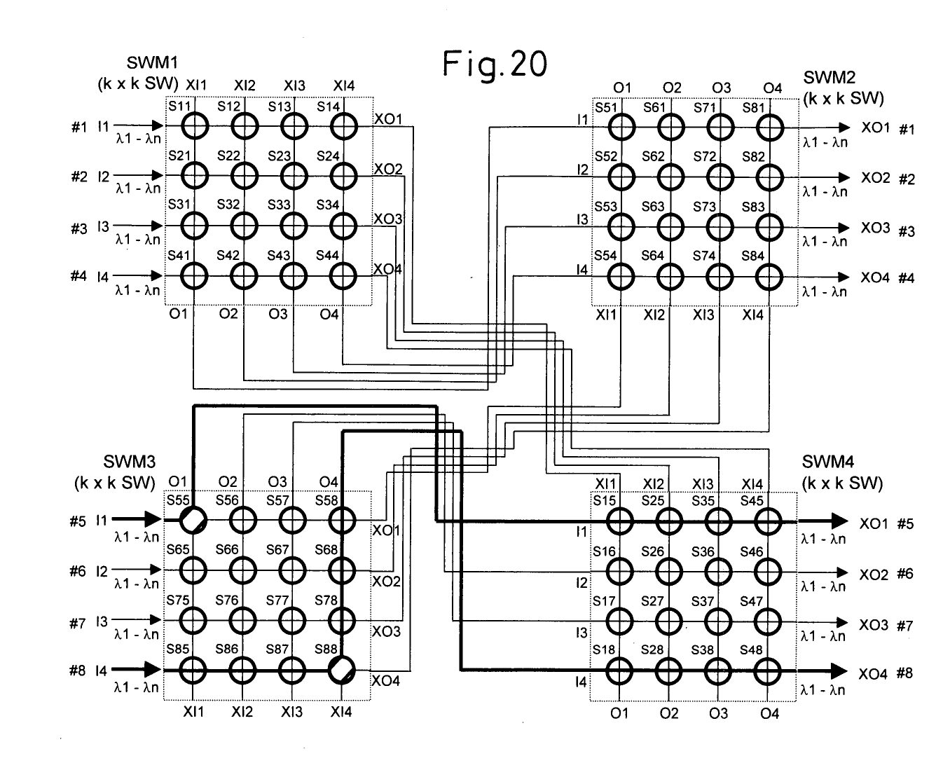

FIG. 20 shows yet another example of the connections between the switch modules. The connections shown are the same as those in FIG. 4 in that all the outputs of the SWM1 and SWM3 are input to SWM2 and SWM4. Accordingly, as shown by thick lines in the figure, the largest number of intervening elements is 11 and the smallest number is 5, the difference being 6.

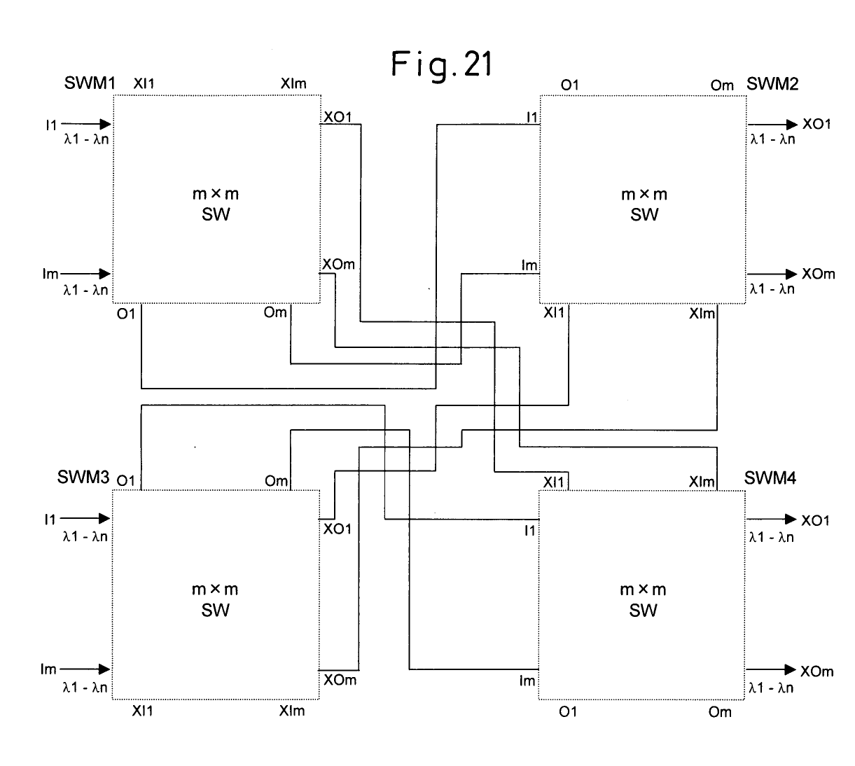

FIG. 21 shows an example in which the connection configuration of FIG. 20 is scaled up in the same manner as that shown in FIG. 12.

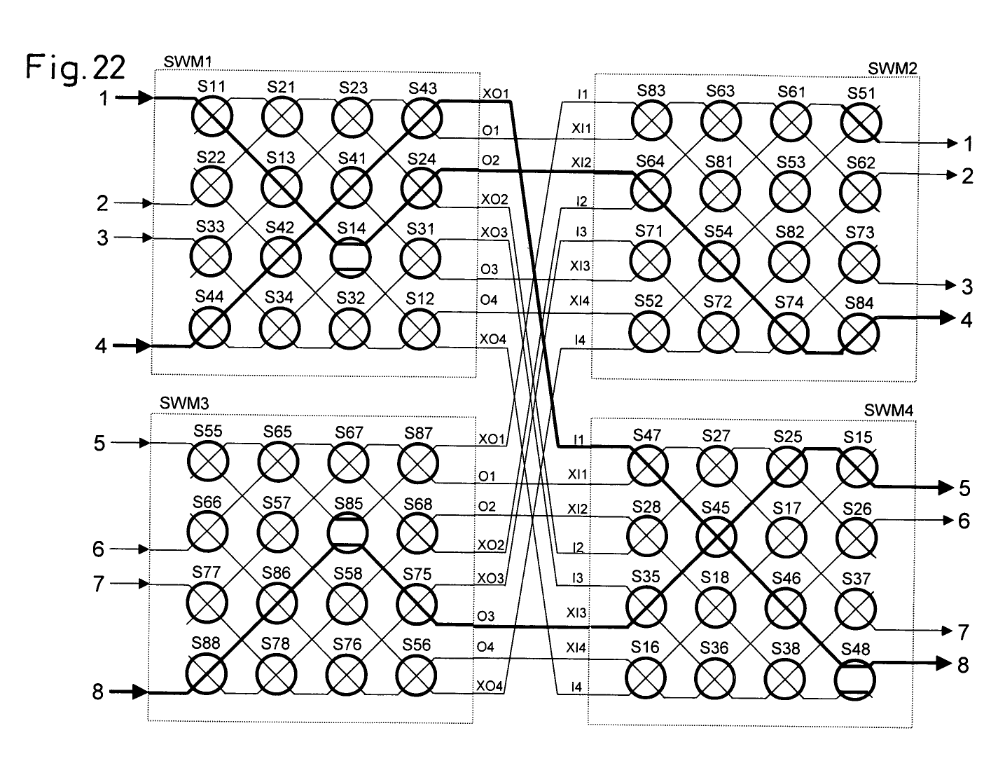

FIG. 22 shows still another example of the optical XC apparatus of the present invention. Switch modules SWM1 to SWM4 are each the same as the PI-LOSS (Path Independent Loss) switch described in Japanese Unexamined Patent Publication No. H06-66982, except that the 2×2 switches in the PI-LOSS switch are replaced by 2×2 wavelength routing elements. Further, as in the optical XC apparatus so far described, the input ports of SWM1 and SWM3 function as the input ports of the apparatus, and the output ports of SWM2 and SWM4 function as the output ports of the apparatus. The connections are the same as those in FIG. 4 in that the auxiliary output ports of SWM1 are connected to the input ports of SWM4 and the output ports of SWM1 are connected to the auxiliary input ports of SWM2, while the auxiliary output ports of SWM3 are connected to the input ports of SWM2 and the output ports on SWM3 are connected to the auxiliary input ports of SWM4. By connecting the ports in this manner, the configuration can be scaled up while retaining the characteristic of the PI-LOSS switch that the number of intervening elements is the same regardless of the route.

When constructing the optical XC apparatus from four PI-LOSS switch modules, not only can the connection configuration of FIG. 4 be employed as shown in FIG. 22, but the connection configuration shown in any one of FIGS. 10, 16, 18, and 20 can also be employed.

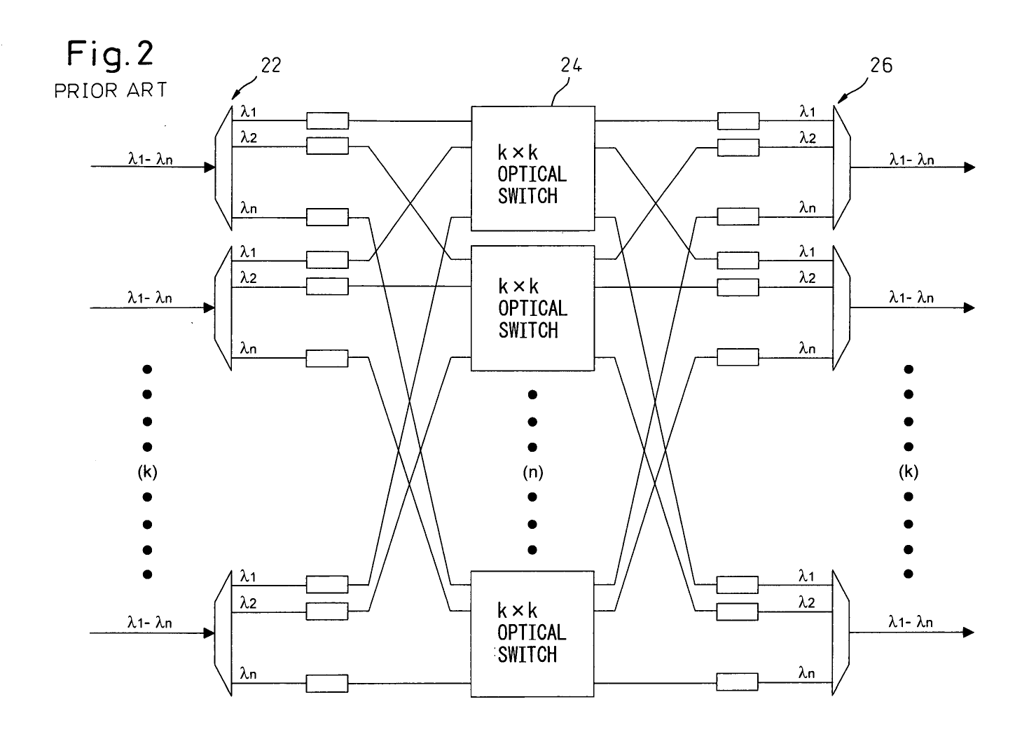

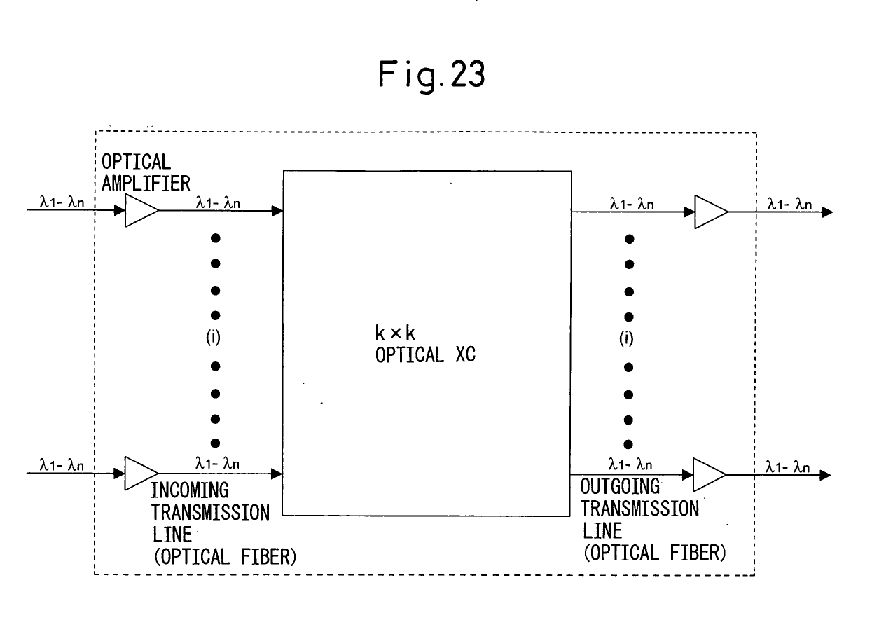

FIG. 23 shows an example in which the optical XC apparatus of the present invention so far described is used in an optical network node. As can be seen from a comparison with FIG. 2, as there is no need to provide an optical switch for each wavelength, an optical XC apparatus that handles WDM signals carrying an enormous number of wavelengths can be achieved with a realistic scale.

1. An optical cross connect apparatus comprising four switch modules each having a plurality of two-input, two-output wavelength routing elements that can take one of two connection states, a cross connection state and a bar connection state, independently of one another for each one of a plurality of wavelengths contained in a wavelength-division multiplexed signal, wherein
said apparatus has input ports on the first and third of said switch modules and output ports on the second and fourth of said switch modules, and
optical outputs of said first and third switch modules are input to said second and fourth switch modules.

2. An optical cross connect apparatus according to claim 1, wherein in each of said first to fourth switch modules, said two-input, two-output wavelength routing elements are arranged one at each crosspoint of a matrix, thereby achieving a matrix switch independent of the others for said plurality of wavelengths.

3. An optical cross connect apparatus according to claim 2, wherein
each output port of said first switch module is connected to one auxiliary input port of said second switch module,
each output port of said third switch module is connected to one auxiliary input port of said fourth switch module,
each auxiliary output port of said first switch module is connected to one input port of said fourth switch module, and
each auxiliary output port of said third switch module is connected to one input port of said second switch module.

4. An optical cross connect apparatus according to claim 3, wherein
the output ports of said first switch module are connected to the auxiliary input ports of said second switch module that have the same depths from the input ports, respectively,
the output ports of said third switch module are connected to the auxiliary input ports of said fourth switch module that have the same depths from the input ports, respectively,
the auxiliary output ports of said first switch module are connected to the input ports of said fourth switch module that have the same depths from the output ports, respectively, and
the auxiliary output ports of said third switch module are connected to the input ports of said second switch module that have the same depths from the output ports, respectively.

5. An optical cross connect apparatus according to claim 4, wherein said input ports are the input ports of said first and third switch modules, and said output ports are the output ports of said second and fourth switch modules.

6. An optical cross connect apparatus according to claim 4, wherein said input ports are the auxiliary input ports of said first and third switch modules, and said output ports are the auxiliary output ports of said second and fourth switch modules.

7. An optical cross connect apparatus according to claim 5, further comprising:
a first level adjuster which gives level differences appropriate to the depths from the output ports, to the wavelength-division multiplexed signal input to the input ports of said first and third switch modules; and
a second level adjuster which gives level differences appropriate to the depths from the input ports, to the wavelength-division multiplexed signal output from the output ports of said second and fourth switch modules.

8. An optical cross connect apparatus according to claim 6, further comprising:
a first level adjuster which gives level differences appropriate to the depths from the auxiliary output ports, to the wavelength-division multiplexed signals input to the auxiliary input ports of said first and third switch modules; and
a second level adjuster which gives level differences appropriate to the depths from the auxiliary input ports, to the wavelength-division multiplexed signals output from the auxiliary output ports of said second and fourth switch modules.

9. An optical cross connect apparatus comprising four switch modules, wherein
each of said switch modules comprises four sub-modules each of which has a plurality of two-input, two-output wavelength routing elements, one at each crosspoint of a matrix, that can take one of two connection states, a cross connection state and a bar connection state, independently of one another for each one of a plurality of wavelengths contained in a wavelength-division multiplexed signal, each of said sub-modules thus achieving a matrix switch independent of the others for said plurality of wavelengths,
each of said switch modules has input ports on the first and third of said sub-modules and output ports on the second and fourth of said sub-modules,
optical outputs of said first and third sub-modules are input to said second and fourth sub-modules,
said apparatus has input ports on the first and third of said switch modules and output ports on the second and fourth of said switch modules, and
optical outputs of said first and third switch modules are input to said second and fourth switch modules.

10. An optical cross connect apparatus according to claim 9, wherein
each output port of said first sub-module is connected to one auxiliary input port of said second sub-module,
each output port of said third sub-module is connected to one auxiliary input port of said fourth sub-module,
each auxiliary output port of said first sub-module is connected to one input port of said fourth sub-module,
each auxiliary output port of said third sub-module is connected to one input port of said second sub-module,
in each of said first to fourth switch modules, the input port and auxiliary input ports of said first and third sub-modules constitute the input port and auxiliary input ports of said each switch module, and the output port and auxiliary output ports of said second and fourth sub-modules constitute the output port and auxiliary output ports of said each switch module,
each output port of said first switch module is connected to one auxiliary input port of said second switch module,
each output port of said third switch module is connected to one auxiliary input port of said fourth switch module,
each auxiliary output port of said first switch module is connected to one input port of said fourth switch module, and
each auxiliary output port of said third switch module is connected to one input port of said second switch module.

11. An optical cross connect apparatus according to claim 10, wherein
the output ports of said first sub-module are connected to the auxiliary input ports of said second sub-module that have the same depths from the input ports, respectively,
the output ports of said third sub-module are connected to the auxiliary input ports of said fourth sub-module that have the same depths from the input ports, respectively,
the auxiliary output ports of said first sub-module are connected to the input ports of said fourth sub-module that have the same depths from the output ports, respectively,
the auxiliary output ports of said third sub-module are connected to the input ports of said second sub-module that have the same depths from the output ports, respectively,
the output ports of said first switch module are connected to the auxiliary input ports of said second switch module that have the same depths from the input ports of the corresponding sub-modules, respectively,
the output ports of said third switch module are connected to the auxiliary input ports of said fourth switch module that have the same depths from the input ports of the corresponding sub-modules, respectively,
the auxiliary output ports of said first switch module are connected to the input ports of said fourth switch module that have the same depths from the output ports of the corresponding sub-modules, respectively, and
the auxiliary output ports of said third switch module are connected to the input ports of said second switch module that have the same depths from the output ports of the corresponding sub-modules, respectively.

12. An optical cross connect apparatus according to claim 11, wherein said input ports are the input ports of said first and third switch modules, and said output ports are the output ports of said second and fourth switch modules, and
in each of said switch modules, said input ports are the input ports of said first and third sub-modules, and said output ports are the output ports of said second-and fourth sub-modules.

13. An optical cross connect apparatus according to claim 11, wherein said input ports are the auxiliary input ports of said first and third switch modules, and said output ports are the auxiliary output ports of said second and fourth switch modules, and
in each of said switch modules, said input ports are the auxiliary input ports of said first and third sub-modules, and said output ports are the auxiliary output ports of said second and fourth sub-modules.

14. An optical cross connect apparatus according to claim 12, further comprising:
a first level adjuster which gives level differences appropriate to the depths from the output ports of said sub-modules, to the wavelength-division multiplexed signal input to the input ports of said first and third switch modules; and
a second level adjuster which gives level differences appropriate to the depths from the input ports of said sub-modules, to the wavelength-division multiplexed signal output from the output ports of said second and fourth switch modules.

15. An optical cross connect apparatus according to claim 13, further comprising:
a first level adjuster which gives level differences appropriate to the depths from the auxiliary output ports of said sub-modules, to the wavelength-division multiplexed signals input to the auxiliary input ports of said first and third switch modules; and
a second level adjuster which gives level differences appropriate to the depths from the auxiliary input ports of said sub-modules, to the wavelength-division multiplexed signals output from the auxiliary output ports of said second and fourth switch modules.

16. An optical cross connect apparatus according to claim 1, wherein said first to fourth switch modules are each a PI-LOSS (Path Independent Loss) switch in which said two-input, two-output wavelength routing elements are arranged one at each crosspoint therein.

17. An optical cross connect apparatus according to claim 16, wherein
each of the output ports of said first PI-LOSS switch is connected to one of the auxiliary input ports of said second PI-LOSS switch,
each of the output ports of said third PI-LOSS switch is connected to one of the auxiliary input ports of said fourth PI-LOSS switch,
each of the auxiliary output ports of said first PI-LOSS switch is connected to one of the input ports of said fourth PI-LOSS switch, and
each of the auxiliary output ports of said third PI-LOSS switch is connected to one of the input ports of said second PI-LOSS switch.
